(19) United States
(12) Patent Application Publication
(10) Pub. No.: US 2017/0214983 A1
(43) Pub. Date: Jul. 27, 2017

(54) WIRED INFORMATION AND PHYSICAL SYSTEM AND METHOD FOR MAKING AND USING THE SAME

(71) Applicant: Shenzhen Wiring Matrix Technologies Co., Ltd., Shenzhen (CN)

(72) Inventors: Daming Peng, Shenzhen (CN); Hailei Zhang, Sammamish, WA (US); Ya Guo, Chengdu (CN); Xintong She, Shenzhen (CN)

(21) Appl. No.: 15/415,899

(22) Filed: Jan. 26, 2017

(30) Foreign Application Priority Data
Jan. 26, 2016 (CN) 2016100509256
Jan. 26, 2016 (CN) 2016100509580
Jan. 26, 2016 (CN) 2016200744232
Jan. 26, 2016 (CN) 2016200744656

(51) Int. Cl. H04Q 1/14; H04Q 1/06; H04L 12/28; H04Q 1/02

(52) U.S. Cl. CPC H04Q 1/14; H04Q 1/03; H04Q 1/06; H04L 12/2803; H04L 2012/2843

(57) ABSTRACT

A wired information and physical system includes a wired system for electric power and data communication, and a background server that is connected to the wired system and performs data storage, processing and analysis. The wired system includes a module-bearing platform and a plurality of function modules removably attached to the platform. The platform and the plurality of the function modules encloses a wire pathway that is further divided into a strong current wire tunnel, a weak current wire tunnel, and a wire duct. A strong current conductive wire is located within the strong current wire tunnel and can provide electric power. A weak current conductive wire and a network cable are located within the weak current wire tunnel, and connect the modules and the server for data and instructions transmission. The system allows reliable control of intelligent terminals and enhances home safety and stability.

### CROSS-REFERENCE TO RELATED APPLICATION

This application claims priority to Chinese Patent Application No. CN2016100509256, filed on Jan. 26, 2016, titled “Integrated Link Device,” Chinese Patent Application No. CN2016100509580, filed on Jan. 26, 2016, titled “A Line-Carried information and Physical System,” Chinese Utility Model Patent Application No. CN2016200744232, filed on Jan. 26, 2016, titled “Integrated Link: Device,” and Chinese Patent Utility Model Application No. CN 2016200744656, filed on Jan. 26, 2016, titled “A Line-Carried Information and Physical System,” which are hereby incorporated by reference in its entirety.

### FIELD

This application relates in general to wiring systems in human dwellings, in particular, to a wired information and physical system that facilitates intelligent management of smart homes and can be extended to all human habitations, including but not limit to, living space, working space, and anyplace where wired transmission of power, signal and data are applicable.

### BACKGROUND

Smart home is a living environment, wherein a residential area is a platform upon which a host of technologies, including wiring technology, network communication technology, security technology, automatic control technology, and audio and video technology are integrated to exercise centralize control and regulation on related devices and facilities, with an aim to improve safety, convenience, comfort, artistic ambiance, environmental protection, and energy conservation.

For successful implementation of a technology, the superiority of the technology itself is indispensable; in addition, another indispensable element is a structure for executing the technology that enables communication and transmission of signals and energies. Currently, smart homes depend almost entirely on wireless communication networks for data transmission, the popular ones including Zigbee, Z_Wave wireless communication technology, WIFI wireless communication technology, etc. One advantage for using wireless communication technologies is the absence of the burden of massive wires in a wired system, however, the trade-ins are several: low stability emanating from easy loss of data; difficulty in safeguarding privacy; and a lack of unified standard for smart home platforms. Thus a large number of terminal devices and equipment employed in day-to-day life cannot be intelligently integrated on a single platform, as a result compatibility is limited to power switches. Also, overall scalability is poor, and products are difficult to expand or scale up. Furthermore, eschewing challenges posed by wiring load is a common phenomenon in the industry. The accumulated outcome from all these conditions is a lack of products that meet user's needs.

Therefore, a need remains for a system and a method to reliably distribute energy, data, and signals in a human dwelling without a massive, messy and cumbersome burden of wirings, while still maintaining high levels of stability, safety, and scalability for the system, which are necessary to meet the need for smart homes, smart offices, etc. and to improve the efficiency for conventional home and buildings.

### SUMMARY

The invention overcomes the deficiencies and shortcomings of prior art by providing a wired structure that are superior in functionalities when compared to wireless structures, and in the same time can be feasibly installed, modified, and managed. The wired information and physical system disclosed in the invention is particularly adapted to alleviate not only the strain imposed by smart home or smart office design and implementation, but also similar tensions in power access and data communication encountered in entire human habitation. The device includes a plurality of function modules, including intelligent terminal modules, attached to a module-bearing platform. The plurality of the function modules is connected to a background server through a network cable. Thus the background server can receive data transmission from and perform management and control over the function modules. The system enhances the safety of smart home or smart office control system, expand its functional range and is associated with strong stability. The module-bearing platform has strong compatibility and scalability for various function modules, enabling a user to add or remove function modules based on needs.

Consistent with above advantages, a wired information and physical system is disclosed, wherein the system comprises a wired system for carrying electric power and transmitting signals and data, and a background server that is connected to the wired system and performs data storage, processing and analysis. The wired system includes a module-bearing platform and a plurality of function modules removably attached to the platform. The platform and the plurality of the function modules encloses a wire pathway that is further divided into a strong current wire tunnel and a weak current wire tunnel. Within the strong current wire tunnel, a strong current conductive wire is installed and configured to be electrically coupled to an external power source such as power mains, distribution mains, or a power line, and further configured to be electrically interfaced with, and to provide strong current electric power to, the at least one of the function modules. Within the weak current wire tunnel, a weak current conductive wire is installed, a network cable may also be installed. The background server is connected to one or more of the function modules via the network cable, and can transmit data and instructions with. the function modules.

In one embodiment of the current invention, the number and the function of the function modules attached on the module-bearing platform can be increased or decreased based on user's needs.

In one embodiment of the current invention, the wire pathway enclosed between the platform and the function modules further comprises a wire duct that houses at least a portion of the weak current conductive wires and at least a portion of the network cables.

In one embodiment of the current invention, at least one power source conversion module is provided as one of the plurality of the function modules. The power source conversion module is connected to the strong current conductive wire. thus can acquire strong current electric power from the external sources such as power mains, distribution mains, and power lines. The power source conversion module can convert strong current to weak current to provide weak current electric power for at least one of the function modules. The least one of the function modules acquire the weak current electric power through connection to the weak current conductive wire, which in turn is electrically coupleable to the power source conversion module.

In one embodiment of the current invention, at least one wireless transceiver module is provided as one of the function modules and is operable to transmit and receive wireless data. The wireless transceiver is connected with the background server via a network cable.

In one embodiment of the current invention, at least one data collection module is provided as one of the function modules.

In one embodiment of the current invention. the data collection module can be light collection module, environmental data collection module, weather and climate data collection module, voice and phonics collection module, human behavior collection module, and video data collection module.

In one embodiment of the current invention, the data collection module transmits collected data to the background server via the network cable, and the background server processes and analyzes the collected data.

In one embodiment of the current invention, at least one function execution module is provided as one of the function modules.

In one embodiment of the current invention, the function execution module is connected with the background server via the network cable, and can execute instructions received from the background server.

In one embodiment of the current invention, the module-bearing platform is a U-shaped module-bearing platform.

In one embodiment of the current invention, the U-shaped module-bearing platform is made of metal or metal alloy.

In one embodiment of the current invention, the U-shaped module-bearing platform and a plurality of the function modules enclose a wire pathway that is further partitioned via metal plates into a strong current wire tunnel, a weak current wire tunnel, and, a wire duct.

In one embodiment of the current invention, the weak current wire tunnel is placed between the strong current wire tunnel and the wire duet; the strong current wire tunnel comprises a neutral wire, a hot wire, and a ground wire, and the neutral wire, the hot wire, and ground wire are placed on the interior wall of the strong current wire tunnel; the weak current wire tunnel comprises two or more weak current conductive Wires and two or more network cables attached to the interior wall of the weak current wire tunnel.

In one embodiment of the current invention, weak current conductive wire and network cable can travel through the wire duct.

In one embodiment of the current invention, each attached function modules has a metal layer on the surface facing the platform.

In one embodiment of the present invention, the plurality of function modules is attached to the module-bearing platform through physical embedding, riveting, screwing, clasping, or adhesion.

In one embodiment of the present invention, a method, is provided for optimizing data communication and electric power access in a human habitation

The present invention is advantageous in many aspects. The background server can perform data transmission with intelligent terminal modules, and execute administration and control, via wires. The wires solve the problems of instability and narrow range of functional control present in the wireless communications in smart home design and implementations. Smart home systems implementing the current invention will enjoy strong safety, wide compatibility, and a wide functional range for the controlled equipment. Easy expandability is also achieved by adding or subtracting function modules based on user's needs.

Still other embodiments will become readily apparent to those skilled in the art from the following detailed description, wherein embodiments are described by way of illustrating the best mode contemplated. As will be realized, other and different embodiments are possible and the embodiments' several details are capable of modifications in various obvious respects, all without departing from their spirit and the scope. Accordingly, the drawings and detailed description are to be regarded as illustrative in nature and not as restrictive.

### BRIEF DESCRIPTION OF THE DRAWINGS

FIG. 1 a block diagram showing a wired information and physical system for optimizing electric power access and data communication, m accordance with one embodiment.

FIG. 2 is prospective view showing the wired information and physical system 10 for providing strong current electric power, weak current electric power, and wired communication conduit, in accordance with one embodiment.

FIG. 3 is a cross section view of the wired information and physical system 10, in accordance with one embodiment.

FIG. 4 is a cross section view of a function module in accordance with one embodiment.

FIG. 5 is a cross section view of a function module in accordance with one embodiment.

FIG. 6 is a cross section view of a function module in accordance with one embodiment.

FIG. 7 is a cross section view of a function module in accordance with one embodiment.

FIG. 8 is a cross section view of a function module in accordance with one embodiment.

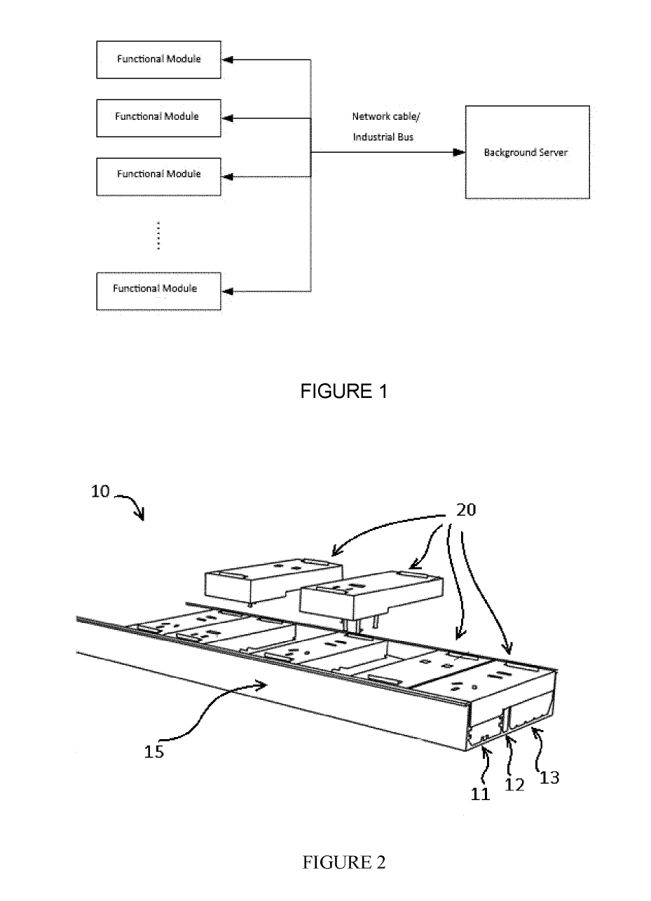

### DETAILED DESCRIPTION

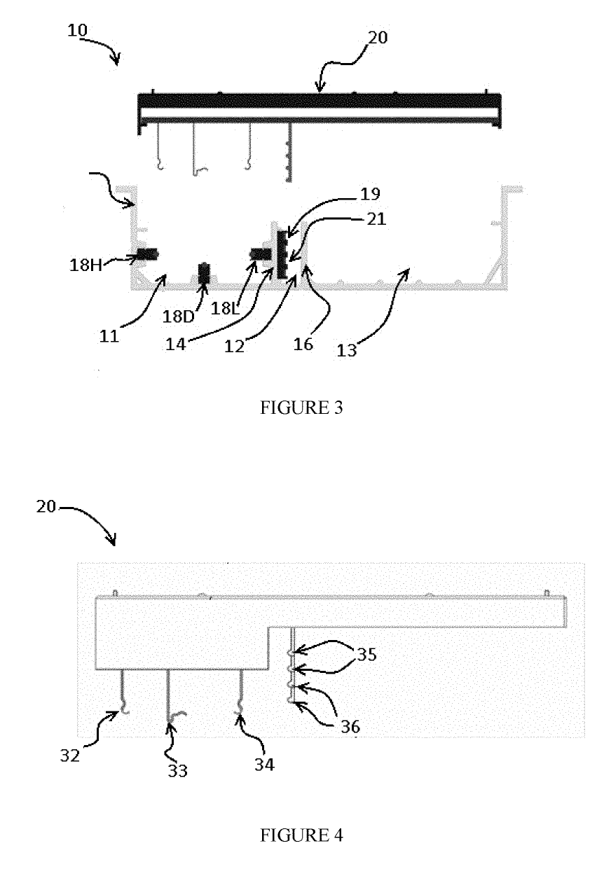

A wired information and physical system 10 is disclosed that facilitates designing and implementation of smart homes and smart offices, and can be useful in other human habitations. As shown in FIGS. 2 and 3, the wiring system 10 provides a module-bearing platform 15 and a plurality of function modules 20 that are detachably or removably, attached or secured to the platform 15. The plurality of the function modules 20 and the platform 15 enclose a tunnel-shaped wire pathway that is further partitioned into a strong current wire tunnel 11 and a weak current wire tunnel 12. The strong current wire tunnel 11 contains a strong current conductive wire that is configured to be connected to an external power source such as power mains, distribution mains or a power line; the weak current wire tunnel 12 contains a weak current conductive wire and a network cable 21 that is configured to be connected to a background server.

In one embodiment, the module-bearing platform 15 is made from metal or alloy material; alternatively, a metal or alloy layer is placed on the interior wall of the module-bearing platform. Furthermore, a strong current/weak current partition 14 is provided that is made of or contains a metal plate. As a result, electro-magnetic interferences between the strong current wire tunnel 11 and the weak current wire tunnel 12 is minimized and the module-bearing platform strongly shields away electro-magnetic waves that cause signal interferences. In some circumstances the wiring system accommodates a large number of weak current wires that may cause interferes to each other and to the network cable 21. To curtail the problem, in one embodiment, a wire duet 13 is partitioned out from the strong current wire tunnel 11 and the weak current wire tunnel 12, by the introduction of a metal partition 16. A portion of the weak current conductive wires 19, as well as the network cable 21, can travel through the wire duct 13, ensuring enhanced safety and low-interference for the system.

The module-bearing platform 15 is an elongated platform that can be mounted in the interior wall, floor, and roof of a building, integrated into building structures such as baseboard, skirting board, frieze, or crown molding, placed on affixed to furniture such as table, desk, and bench; or positioned to places where wire connections for electric power, signal and data transmission are applicable. The cross-section of the platform 15 can be shaped as a semi-circle, semi-ellipse, and polygonal. Other shapes are possible. In one embodiment, the module-bearing platform 10 is a U-shaped module-bearing platform when viewed through a cross section, as shown in FIG. 3. For illustrative purpose, the function module 20 in FIG. 3 is depicted in a detached position relative to the platform 15. The function module 20 can be handily attached to or detached from the platform 15 through a reversible locking member 17 such as a clasp, a pivot, a lock, or an adhesive member. The wire pathway thus enclosed by the function module 20 and the platform 15 are further partitioned by metal plates into the strong current wire tunnel 11, the weak current wire tunnel 12, and the wire duct 13. In one preferred embodiment, the weak current wire tunnel 12 is located between the strong current wire tunnel 11 and the wire duct 13; furthermore, the strong current wire tunnel contains the strong current conductive wire comprising, a hot wire 18H, a ground wire 18D, and a neutral wire 18L, all affixed to the interior wall, of the strong current wire tunnel 11; furthermore, in one embodiment, at least two weak current conductive wires 19 and at least two network cables are affixed to the interior wall of the weak current wire tunnel 12. One or more network cables can be fastened to the interior wall of the wire duct 13. As can be appreciated by those skilled in the art, the relative positions of the strong current wire tunnel 11, the weak current wire tunnel 12, and the wire duct 13 can vary in accordance with need and is not limited what is described in figures. In addition, the neutral wire 18D, the hot wire 18H, the ground wire 18L, two weak current conductive wires 19, and two network cables may also be placed in other positions as dictated by needs. They can be affixed to the interior wall by fastening adhesion, attachment, or other means, or placed without fixed attachment.

In one embodiment of the present invention, a layer of insulation material is placed on the interior wall of the strong current wire tunnel 11. The protective layer minimizes the risk of electric shock to a user and enhances the safety of the system.

In one embodiment of the current invention, a metal layer is provided to cover the function module surface that faces the module-bearing platform 15. The function modules 20 can be standardized in uniform size and attached to the module-bearing platform 15 by ways of physical embedding, riveting, screwing, clasping, or adhesion, among other methods. Alternatively, the function modules 20 can be made into varying sizes and placed onto the module-bearing platform 15. In some embodiments, the function modules 20 are permanently attached to the platform 15. In other embodiments, the function modules 20 can be added to or removed from the module-bearing platform 15 based on needs. When the attachment of the function modules to the module-bearing platform is detachable and reversible, one or more function modules can be easily secured into or removed from the platform, based on user's preference or application environment.

In one embodiment of the present invention, the strong current conductive wire is configured to be electrically coupleable to one or more function modules 20. The strong current conductive wire is also electrically coupleable to an external power source such as power mains, distribution mains, or a municipal power line, thus the strong current conductive wire can provide the one or more function modules 20 with strong current electric power. In some embodiments all function modules 20 are configured to couple to an external power source; in other embodiments none of the function modules 20 are coupled to the external power source. As shown in FIG. 4, a function module 20 configured to be electrically interfaced with the external power source is provided with a hot wire contact interface 32, a ground wire interface 33, and a neutral wire interface 34, the latter three are operable to become electrically interfaced with the hot wire 18H, the ground wire 18D, and the neutral wire 18L, respectively. The electric coupling can be activated by attaching the function module 20 to the platform 15, or through an on/off trigger such as a push button. In addition, one or more function modules 20 can communicate data with background server through the network cable 21 that links the one or more function modules to the background server.

In one embodiment, the plurality of function modules 20 include at least one power source switching module, which can be connected to the strong current conductive wire and operable to convert strong current electric power into weak current electric power required for some other function modules 20. As shown in FIGS. 3 and 4, the power source switching module acquires strong current electric power though connections between the hot wire contact interface 32 to hot wire 18H, the ground wire contact interface 33 to the ground wire 18D, and the neutral wire contact interface 34 to the neutral wire 18L, respectively. The power source switching module convert the strong current electric power, such as 110V, 60 Hz electricity, into weak current electric power, such as 5V or 20V direct current, or other voltages. The power source switching module has one or more weak current contact interface 35 that are configured to electrically interface with the weak current conductive wire 19 located within the weak current wire tunnel 12, and can provide weak current electric power, such as 5V or 20V direct current, or other voltages, to other function modules that are electrically coupled to the weak current conductive wire 19 through their own weak current contact interface 35.

Weak current refers to electric current of extra low voltage such as 5V or 20V. Weak currents are widely used to operate many electrical engineering systems in human habitation, including fire alarm detection system, audiovisual systems, building automation and building management system, master clock system, nurse call system, public address system, security systems, data networks systems, and telephone systems.

In one embodiment, one or more function modules 20 can he a wireless transceiver that transmit or receive wireless data. The wireless transceiver is connected with the background server via a network cable 21, This, if other function modules need to communicate with a wireless communication equipment, the wireless transceiver can fulfill the need by both communicating with, the wireless communication equipment wirelessly and communicating with the other function modules through wire. In some embodiments, wireless transceiver can be WIFI wireless transceiver, Zigbee wireless transceiver, Z-Wave wireless transceiver, Bluetooth wireless transceiver, and infrared wireless transceiver such as infrared controller.

In one embodiment, one or more function modules 20 are data collection module, function execution module, or a combination thereof. The data collection module transfers collected data to the background server via the network cable 21, and the background server processes and analyzes the collected data. After processing and analyzing, instructions are sent to the function execution module via the network cable 21 when needed. In another embodiment, a data collection module may be equipped with a data processer and perform initial analyses and processing before sending out the processed data to the background server via the network cable 21. In still another embodiment, a data collection module may be provided with a data processor, perform analyses and processing on collected data, and directly transmit via the network cable 21 commands or instructions to the function execution module, bypassing the background server. In yet another embodiment, the data collection model and the function execution model are integrated into one and same function module. Data collection module includes senor modules used in human habitations, such as light collection module, environmental data collection module, weather and climate data collection module, voice and phonics collection module, human behavior data collection module, and video data collection module, among others.

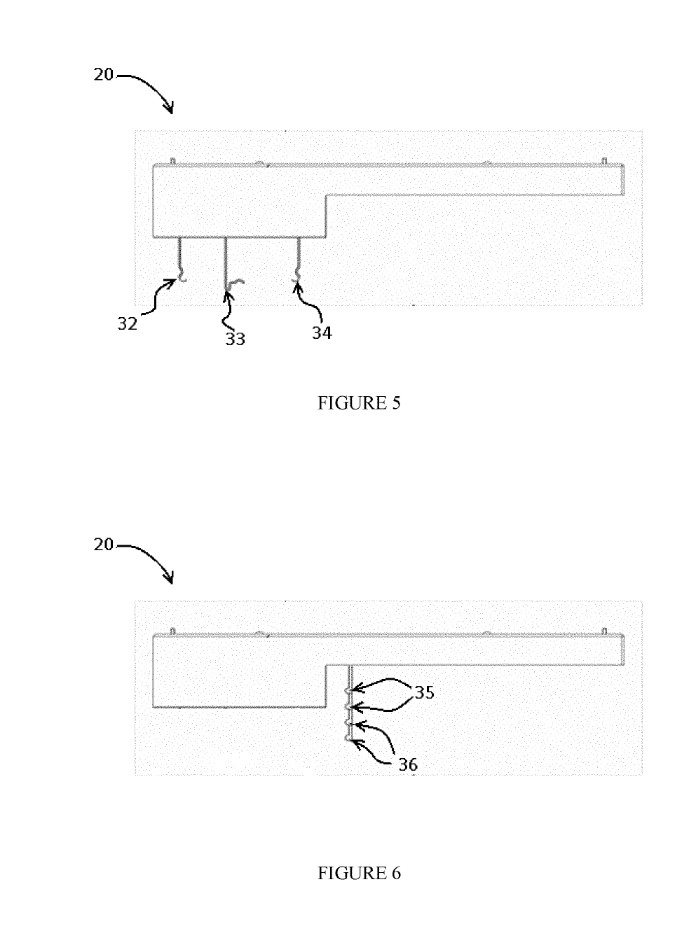

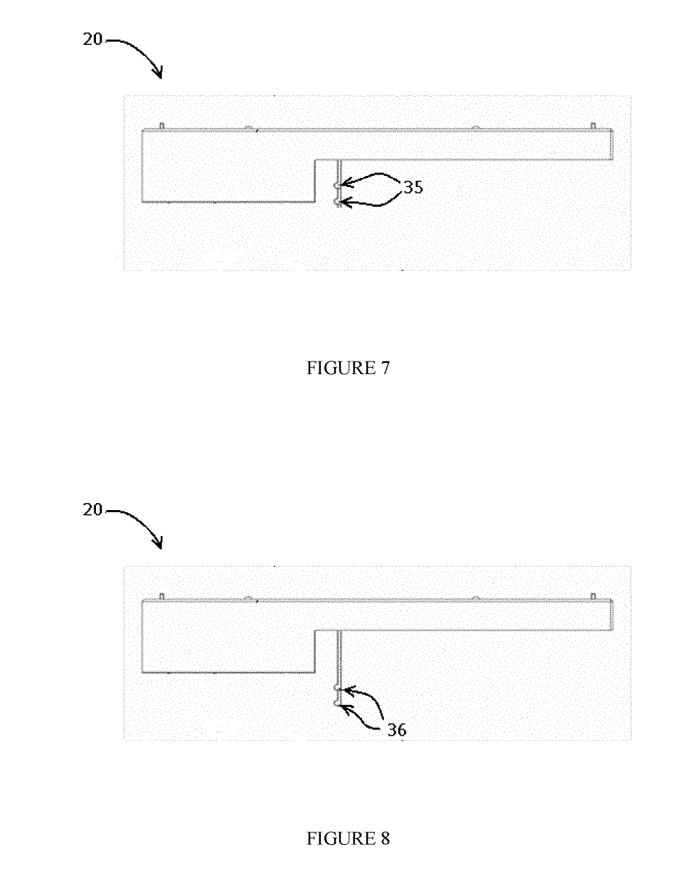

In one embodiment, function modules that vary both structurally and functionally are used. As shown in FIG. 5, one type of function module is limited to acquiring electric power from power lines, such as a socket or receptacle. This type of function module has the hot wire contact interface 32 configured to couple to the hot wire 18H, the ground wire contact interface 33 configured to couple to the ground wire 18D, and the neutral wire contact interface 34 configured to couple to the neutral wire 18L, respectively. As shown in FIG. 6, another type of function module is specialized for communicating with background servers. This type of function module has the weak current contact interface 35 configured to electrically link to the weak current conductive wire 19 in order to get weak current electric power. This type of function module also has the network cable interface interface 36 configured to link to network cable 21 and transmits data to a background server. Examples of this type of function modules include gas sensors,

As shown in FIG. 6, still another type of function module is a weak current electric power outlet, such as USB outlet, that has a weak current contact interface 35 configured to interface with weak current conductive wire 19 to conduct weak current electric power. As shown in FIG. 8, yet another type of function module has its own power source and network cable interface interface 36 that is configured to connect to the network cable 21. Examples of this type of function modules includes many data collection modules and execution modules. Other combinations, formats, and variations are possible.

Network cables are network hardware used to connect one network device to other network devices or to connect server or computers to each other or to a network device. In some embodiments, different types of network cables, such as Ethernet, coaxial cable, twisted pair cables, fiber optic cable and optical fiber cable can be used. In at least some of the embodiments, industrial buses can be used in lieu of network cables. The industrial bus includes CAN industrial bus and 485 industrial bus.

Through network cables 21, the function modules can communicate not only with the background server that hosts the central logic of a home system, but also among different modules themselves, providing enhanced design flexibility. Wireless communication can also be incorporated into the wired communication in the system. The function modules, interconnected in the system, can act in response to instructions sent from the background server, based on modules' own logic, environmental cues, or status of other function modules. The communication can be states, instructions and data. The protocol for communication on cables can be TCP/IP, UDP and any other types. The wireless communication protocol can be WIFI, Zigbee, and any other protocols.

As described, a wired information and physical system is disclosed that includes a module-bearing platform 15 and a plurality of function modules 20 used in human habitation that are attached to the platform 15. The plurality of function modules 20 are connected to weak current conductive wire 19 and network cables 21 through physical wires. Such a configuration solves the instability problem prevalent in wireless communication of smart home system. The device disclosed in the present invention also has strong safety features when applied in human habitation and enhances compatibility. Finally, the device disclosed in the present invention has great scalability since various function modules can be added or removed easily based on user's needs.

A method is disclosed that optimizes data communication and electric power access in a human habitation, The method includes the step of providing a wired information and physical system for carrying electric power and transmitting signals and data. To do so, a module-bearing platform 15 is provided; a plurality of function modules 20 is removably secured to the platform, wherein the platform 15 and the plurality of the function modules 20 encloses a wire pathway that is further divided into a strong current wire tunnel 11, a weak current wire tunnel 12 , and a wire duct 13; a strong current conductive wire is provided within the strong current wire tunnel 11 and configured to be electrically coupled to an external power source, and further configured to be electrically interfaced with, and to provide strong current electric power to, at least one of the function module; a weak current conductive wire 19 is provided within the weak current wire tunnel 12; wherein the weak current conductive wire 19 is electrically interfaced with one or more function modules 20; and finally, one or more network cable 21 is provided within the wire duct. The method also includes the step of providing a background server configured to connect to, and transmit data to and from, the one or more function modules 20 via the network cable 21.

In one embodiment, electro-magnetic interference can be minimized by the steps of: providing, within the wire pathway, a wire duct 13 operable to allow the passage of the weak current conductive wire 19; separating the wire duct 13, the strong current wire tunnel 11, and the weak current wire tunnel 12 with metal plates; and providing a metal layer over the interior walls of the module-bearing platform and over function modules 20 surface facing towards the module-bearing platform.

In one embodiment, at least one power source conversion module is provided that is connected to both the strong current conductive wire and the weak current conductive wire 19, and operable to convert strong current to weak current to provide electric power to the one or more function modules 20 through the weak current conductive wire 19; at least one data collection module is provided as one of the function modules; data collection module collects data and transmits the data to the background server through the network cable 21.

While the invention has been particularly shown and described as referenced to the embodiments thereof, those skilled in the art will understand that the foregoing and other changes in form and detail may be made therein without departing from the spirit and scope. The embodiments described above are preferred embodiments of the present invention, but the embodiments of the present invention are not limited to the above-described embodiments, and other changes, modifications, substitutions, combinations, abbreviations, and equivalents may be made without departing from the spirit and principle of the present invention, and are to be construed as equivalent permutations and are intended to be included within the scope of the present invention.

What is claimed is:

1. A wired information and physical system, comprising:
a wired system for carrying electric power and transmitting signals and data, comprising:
a module-bearing platform;
a plurality of function modules removably attached to the platform, wherein the platform and the plurality of the function modules enclose a wire pathway that is further divided into a strong current wire tunnel and a weak current wire tunnel;
a strong current conductive wire located within the strong current wire tunnel and operable to be electrically coupled to an external power source, and further configured to be electrically interfaced with at least one of the function modules
a weak current conductive wire located within the weak current wire tunnel; and
a network cable located within the weak current wire tunnel; and
a background server configured to connect to, and transmit data with, one or more of the function modules via the network cable.

2. A wired information and physical system according to claim 1, wherein the number and the function of the function modules attached to the module-bearing platform can be increased or decreased based on needs.

3. A wired information and physical system according to claim 1, further comprising:
a wire duct located within the wire pathway enclosed by the platform and the plurality of the function modules, and configured to house the weak current conductive wire and the network cable.

4. A wired information and physical system according to claim 1, further comprising:
at least one power source conversion module, being part of the function modules, the power source conversion module being configured to connect to the strong current conductive wire and convert strong current to weak current to provide electric power for at least one of the function modules, wherein the at least one of the function modules acquire the weak current electric power through the weak current conductive wire electrically coupled to the power source conversion module.

5. A wired information and physical system according to Claim I, furthers comprising:
at least one wireless transceiver module, being part of the function modules, and operable to transmit and receive wireless data, wherein the wireless transceiver is connected with the background server via a network cable.

6. A wired information and physical system according to claim 1, further comprising:
at least one data collection module as one of the function modules.

7. information and physical system according to claim 6, wherein the data collection module is operable to transmit collected data to the background server via the network cable, wherein the background server processes and analyzes the collected data.

8. A wired information and physical system according to claim 1, wherein the data collection module is selected from the group of light collection module, environmental data collection module, weather and climate data collection module, voice and phonics collection module, human behavior collection module, and video data collection module.

9. A wired information and physical system according to claim 1, further comprising:
at least one function execution module as one of the function modules.

10. A wired information and physical system according to claim 9, wherein the function execution module is configured to connect with the background server via the network cable, and to execute instructions received from the background server.

11. A wired information and physical system according to claim 1, wherein the module-bearing platform is a U-shaped platform.

12. A wired information and physical system according to claim 11, wherein the U-shaped platform is made of metal,

13. A wired information and physical system according to claim 1, further comprising:
one or more metallic plates that divides the wire pathway enclosed by the platform and the plurality of the function modules into the strong current wire tunnel, the weak current wire tunnel, and a wire duct.

14. A physical wiring system according to claim 13, wherein the weak current wire tunnel is located between the strong current wire tunnel and the wire duct, and further comprising:
a hot wire, and a ground wire, and a neutral wire, all comprised of the strong current conductive wire, wherein the hot wire, the ground wire and the neutral wire are affixed onto the interior walls of the strong current wire tunnel;
at least two weak current conductive wires affixed onto an interior wall of the weak current wire tunnel; and
at least two network cables affixed onto an interior wall of the weak current wire tunnel.

15. A wired information and physical system according to claim 1, further comprising:
a metal layer comprised of the attached function modules and located on the surface facing the platform.

16. A wired information and physical system according to claim 1, wherein the function modules are attached to the platform through a method chosen from the group of physical embedding, riveting, screwing, clasping, and adhesion.

17. wired information and physical system according to claim 1, wherein the network cable is selected from the group of Ethernet, coaxial cable, twisted pair cables, and fiber optic cable.

18. A method for optimizing data communication and electric power access in a human habitation, comprising the steps of;
providing a wired system for carrying electric power and transmitting signals and data, further comprising the steps:
providing a module-bearing platform;
securing a plurality of function modules removably to the platform, wherein the platform and the plurality of the function modules enclose a wire pathway that is further divided into a strong current wire tunnel, a weak current wire tunnel, and a wire duct;
attaching a strong current conductive wire located within the strong current wire tunnel and configured to be electrically coupled to an external power source, and further configured to be electrically interfaced with, and to provide strong current electric power to, at least one of the function module;
attaching a weak current conductive wire located within the weak current wire tunnel; wherein the weak current conductive wire is electrically interfaced with at least one of the function modules; and
providing a network cable located within the wire duct; and
providing a background server configured to connect to, and transmit data with, the one or more function modules via the network cable.

19. A method according to claim 19, further comprising the steps of:
providing at least one power source conversion module configured to connect to both the strong current conductive wire and the weak current conductive wire, and operable to convert strong current to weak current to provide electric power to the at least one of the function modules through the weak current conductive wire;
providing at least one data collection module among the one or more function modules;
collecting data via the at least one data collection module and transmitting the data to the background server through the network cable.

20. A method according to claim 19 according to claim 19, further comprising the steps of:
providing a wire duct within the wire pathway operable to house the weak current conductive wire and the network cable;
separating the wire duct, the strong current wire tunnel, and the weak current wire tunnel with metal plates; and
providing a metal layer over the interior walls of the module-hearing platform and over function modules surface facing towards the module-hearing, platform.
